(19) United States
(12) Patent Application Publication
(10) Pub. No.: US 2012/0066852 A1
(43) Pub. Date: Mar. 22, 2012

(54) WIPES COMPRISING A DE-DENSIFIED FIBROUS STRUCTURE

(75) Inventors: Michael Jan TRINKAUS, Bad Soden (DE); Gueltekin ERDEM, Schwalbach am Taunus (DE)

(73) Assignee: The Procter & Gamble Company, Cincinnati, OH (US)

(21) Appl. No.: 13/236,809

(22) Filed: Sep. 20, 2011

(30) Foreign Application Priority Data
Sep. 21, 2010 (EP) 10010028.8

(51) Int. Cl. B08B 1/00

(52) U.S. Cl. 15/104.93

(57) ABSTRACT

A fibrous material suitable for making wipes is provided. The fibrous material comprises a mixture of high denier thermoplastic fibers, low denier thermoplastic fibers and an opacifying agent.

### CROSS REFERENCE TO RELATED APPLICATIONS

This application claims priority to EP 10010028.8, filed Sep. 21, 2010, which is hereby incorporated by reference in its entirety.

### FIELD OF THE INVENTION

The present invention relates to fibrous materials suitable for making wipes which comprise a mixture of high denier thermoplastic fibers, low denier thermoplastic fibers and opacifying agent.

### BACKGROUND OF THE INVENTION

Disposable wipes, either wet or dry, are well-known and successfully commercialized for a large variety of uses. For instance, wipes may be used for cleaning hard surfaces such as floors or kitchen surfaces. Wipes may also be used for personal cleaning, for example to remove facial make-up or to clean or refresh the skin whilst traveling. Wipes are also particularly appreciated for cleaning baby's skin in the perineal area during a diaper change.

Typically, wipes comprise a substrate, in the form of a woven or nonwoven sheet. The sheet may be impregnated with a lotion composition wetting the substrate to facilitate cleaning and providing a so-called wet wipe. The lotion composition may deliver additional benefits, e.g. soothing or treating.

Various types of substrates, differing in their visual and tactile properties, may be utilized for manufacturing disposable wipes. When wipes are intended to be used as personal care wipes, such as baby wipes, facial cleansing wipes, intimate cleansing wipes, and the like, softness, flexibility, coverage, effective cleaning ability, thickness, strength are properties that matter for the consumers. Another desirable wipes property is opacity. Durable wipes typically are opaque and thus, quite often, opacity is associated with quality, appropriate bulk, strength, and other desirable characteristics of a wipe, leading to a better overall user acceptability.

Over the past decades, research and development efforts were aimed at developing new substrates suitable for manufacturing wipes meeting these expectations.

In the course of these research and developments, it was found that maintaining a right balance of properties is challenging. Typically, when one property is improved, other properties of the substrate may be adversely affected. In addition to this challenge, manufacturers have to control the manufacturing/producing costs in order to deliver wipes at competitive prices, which can find wide acceptance among consumers. Today, this is even more challenging since commodities prices, e.g. raw materials costs, have considerably increased.

To reduce cost, wipes manufacturers have attempted to reduce the amount of fibers in these materials to provide substrates of lower basis weight. However, this solution is not completely satisfactory. Consumers may notice the basis weight reduction and as a result, their confidence in the cleaning efficiency of the wipes may be negatively affected. Furthermore, basis weight reduction may also affect the physical properties of the wipes. For instance, the thickness, strength, opacity or coverage of wipes, well known as desirable attributes for wipes, may be reduced to levels more or less acceptable by the consumers.

Thus, it remains a need for wipes, either dry or wet, that would exhibit a right balance of properties, e.g. strength, flexibility, thickness, opacity, coverage and that would be manufactured without incremental costs, and even at lower costs. The wipes should remain thick enough to make the consumer confident in the cleaning performance of the wipes and provide good hand coverage during the cleaning tasks. The wipes should also be soft to the skin, flexible, strong and visually attractive.

It has been found that fibrous materials comprising a right combination of low denier thermoplastic shaped fibers, high denier thermoplastic fibers and opacifying agent are suitable for making wipes meeting these expectations. Furthermore, it has been found that fibrous materials comprising a right combination of low denier thermoplastic shaped fibers, high denier thermoplastic fibers and opacifying agent are suitable for making wipes of reduced basis weight, of which the strength, opacity and thickness are not negatively affected.

### SUMMARY OF THE INVENTION

A wipe comprising a sheet of fibrous material comprising from 20% to 90%, by weight of the total amount of fibers, of thermoplastic shaped fibers having a denier of up to 1.2 dpf, from 10% to 80%, by weight of the total amount of fibers, of thermoplastic fibers having a denier of at least 2.2 dpf and at least 0.2%, by weight of dry fibrous material, of an opacifying agent.

A wet wipe comprising a sheet of fibrous material having a basis weight comprised from 30 g/m² to 45 g/m² and comprising from 20% to 90%, by weight of the total amount of fibers, of thermoplastic shaped fibers having a denier of up to 1.2 dpf, from 10% to 80%, by weight of the total amount of fibers, of thermoplastic fibers having a denier of at least 2.2 dpf and from 0.4% to 4%, by weight of dry fibrous material, of an opacifying agent and exhibiting an opacity of from 45 to 65% , a CD tensile strength of from 12 to 30 N and a caliper of from 0.45 to 0.8 mm is also provided.

### DETAILED DESCRIPTION OF THE INVENTION

The present disclosure is directed to a distinctive wipe comprising a sheet of fibrous material comprising from 20% to 90%, by weight of the total amount of fibers, of thermoplastic shaped fibers having a denier up to 1.2 dpf (referred herein as “low denier thermoplastic fibers”), from 10% to 80%, by weight of the total amount of fibers, of thermoplastic fibers having a denier of at least 2.2 dpf (referred herein as “high denier thermoplastic fibers”) and at least 0.2%, by weight of the dry fibrous material, of an opacifying agent.

At basis weight parity, the wipes according to the present disclosure exhibit improved physical properties, i.e. higher strength, higher thickness and higher opacity, than conventional wipes not comprising the particular combination of high denier/low denier thermoplastic fibers. The term “wipe” as used herein, refers to an article comprising a sheet of fibrous material.

Wipes are also known to as “cleaning sheet”. Wipes, either dry or wet, are intended to be used for removal of a substance from a surface or object which is animate or inanimate, or alternatively, application of a material to a surface or object which is animate or inanimate. For instance, wipes may be used for cleaning hard surfaces, such as floors. Wipes may also be used for human or animal cleansing or wiping such as anal cleansing, perineal cleansing, genital cleansing, and face and hand cleansing. Wipes may also be used for application of substances to the body, including but not limited to application of make-up, skin conditioners, ointments, and medications. They may also be used for cleaning or grooming of pets. Additionally, they may be used for general cleansing of surfaces and objects, such as household kitchen and bathroom surfaces, eyeglasses, exercise and athletic equipment, automotive surfaces, and the like.

The wipe may have a variety of shapes, including but not limited to, circular, square, rectangular, oval, or irregularly shaped. However, generally, a wipe is rectangular or square in shape and is defined by two pairs of opposite sides or edges. Each wipe has a width and a length. For example, the wipe may have a length of from about 6 to about 40 cm, or from about 10 to about 25 cm, or from about 15 to about 23 cm, or from about 17 to about 21 cm and may have a width of from about 10 to 25 cm, or from about 15 to about 23 cm, or from about 17 to about 21 cm. Each individual wipe may be arranged in a folded configuration and stacked one on top of the other to provide a stack of wipes. Such folded configurations are well known to those skilled in the art and include c-folded, z-folded, quarter-folded configurations and so forth.

The term “denier” as used herein refers to a unit used to indicate the fineness of a filament/fiber. The unit expresses the mass of a filament/fiber in grams per 9000 meters of length. As used herein with respect to the fibrous material, the term CD or “cross-direction” refers to the direction, in the plane of the fibrous material, perpendicular to the machine-direction. The term “machine-direction” refers to the direction of travel as the fibrous material is produced, for example on nonwoven making equipment. With respect to individual wipes or sheets, the terms “machine-direction” and “cross-machine direction” refer to the corresponding directions of the wipes/sheets with respect to the fibrous material the wipe/sheet was made from.

The term “gsm” as used herein refers herein to “grams per square meter” (g/m²).

As used herein, the term “shaped fiber” refers to “non-round fibers”, i.e. fibers having a non-round cross-section. Shaped fibers can be of various cross-sectional shapes. Such fibers can be solid or hollow.

The term “opacifying agent” as used herein refers to an agent that enhances the opacity of the fibrous material.

The term “basis weight” as used herein refers to the weight per unit area of the wipe.

The term “thermoplastic” as used herein refers to a polymer that flows under shear when exposed to heat and returns to its original condition when cooled to room temperature. Examples of thermoplastic materials include, but are not limited to, styrene polymers and copolymers, acrylics, polyethylenes, polypropylenes, vinyls and nylon.

All the percentages given herein refer to the weight of a component as a percent of the total unless indicated otherwise.

In the following, each of the constituents of the sheet of fibrous material suitable for making the wipe of the invention is described in greater details.

Low Denier Thermoplastic Shaped Fibers

The fibrous material of the invention comprises thermoplastic shaped fibers of low denier. “Thermoplastic shaped fibers of low denier” or “low denier thermoplastic shaped fibers” as used herein, means thermoplastic shaped fibers having a denier up to 1.2 dpf. Suitably, the low denier thermoplastic shaped fibers may have a denier in the range of from 0.6 dpf to 1.2 dpf, or from 0.7 dpf to 1.1 dpf, or from 0.8 dpf to 1.1 dpf, or from 0.8 to 1 dpf, or from 0.9 to 1 dpf.

The low denier thermoplastic fibers may result from the decomposition of splittable fibers. For instance, splittable fibers may split into individual low denier thermoplastic fibers when hydroentangling the fibrous structure. The splittable fibers may be composed of at least two threads, e.g. from 2 to 14 threads of different polymers, be they homopolymers, copolymers or mixtures thereof. The polymers may be selected from polyolefins (polypropylene and polypropylene copolymers, polyethylene and polyethylene copolymers), polyesters, polyamides, polyimide, polylactic acid, polyhydroxyalkanoate, polyvinyl alcohol, ethylene vinyl alcohol, nylon, polyacrylates, and copolymers thereof and mixture thereof.

The low denier thermoplastic shaped fibers may be continuous fibers, also called filaments, or they may be staple fibers having a length of from 15 mm to 70 mm, or from 25 mm to 60 mm or from 30 mm to 50 mm.

The low denier thermoplastic shaped fibers may consist of various multi-lobal shaped fibers such as the most commonly encountered trilobal shaped fibers version. Other multi-lobal shaped fibers include, but are not limited to, bilobal, quatro-lobal shaped fibers. The thermoplastic shaped fibers may also include delta shaped, concave delta shaped, crescent shaped, oval shaped, star shaped, trapezoid shaped, square shaped, diamond shaped, U-shaped, H-shaped, C-shaped, V-shaped or other suitable shaped fibers or any combinations thereof. The low denier thermoplastic shaped fibers may include any combinations of the above mentioned shaped fibers. The thermoplastic shaped fibers may be solid or hollow fibers.

The low denier thermoplastic shaped fibers include, but are not limited to, fibers made of polyolefins (polypropylene and polypropylene copolymers, polyethylene and polyethylene copolymers), polyesters, polyamides, polyimide, polylactic acid, polyhydroxyalkanoate, polyvinyl alcohol, ethylene vinyl alcohol, nylon, polyacrylates, and copolymers thereof and mixtures thereof. The low denier thermoplastic shaped fibers may comprise an opacifying agent, as disclosed herein below, in their polymer formulation to increase the opacity of the fibrous material made therefrom.

The low denier thermoplastic shaped fibers may be multi-component fibers. Multi-component fibers, commonly bi-component fibers, may be in a side-by-side, sheath-core, segmented pie, ribbon, or islands-in-the-sea configuration. The sheath may be continuous or non-continuous around the core. When present, a hollow region in the fiber may be singular in number or multiple.

Examples of suitable low denier thermoplastic shaped fibers include, but are not limited to staple trilobal polypropylene fibers (0.9 denier, 38 mm) comprising 1% TiO₂ (w/w) as supplied by FiberVisions (7101 Alcovy Road Covington, Ga., USA 30014) or staple trilobal polypropylene fibers (1.2 denier, 38 mm) comprising 0.5% TiO₂ (w/w) as supplied by FiberVisions (7101 Alcovy Road Covington, Ga., USA 30014).

High Denier Thermoplastic Fibers

The fibrous material of the invention comprises thermoplastic fibers of high denier. “Thermoplastic fibers of high denier” or “high denier thermoplastic fibers” as used herein means thermoplastic fibers having a denier of at least 2.2 dpf. Suitably, the high denier thermoplastic fibers may have a denier in the range of from 2.2 dpf to 6 dpf, or from 2.5 dpf to 5 dpf or from 2.8 dpf to 4.5 dpf.

The high denier thermoplastic fibers may be continuous fibers, i.e. filaments or they may be staple fibers having a length of from 15 mm to 70 mm, or from 25 mm to 60 mm, or from 30 mm to 50 mm.

The high denier thermoplastic fibers may be solid round fibers, hollow round fibers and/or shaped fibers. When the high denier thermoplastic fibers are shaped fibers, they may consist of multi-lobal shaped fibers, e.g. bilobal fibers, trilobal fibers, quatro-lobal fibers, or delta shaped, concave delta shaped, crescent shaped, oval shaped, trapezoid shaped, star shaped, square shaped, diamond shaped, U-shaped, H-shaped, C-shaped, V-shaped or other suitable shaped fibers or combination thereof. The multi-lobal shaped fibers may be solid or hollow fibers.

In embodiments wherein the high denier thermoplastic fibers are shaped fibers, low denier thermoplastic shaped fibers and high denier thermoplastic fibers may have a same shape. For instance, in some embodiments, the low denier thermoplastic shaped fibers and the high denier thermoplastic fibers may be trilobal shaped fibers. In some embodiments, the low denier thermoplastic shaped fibers may be trilobal fibers and the high denier thermoplastic fibers may be round fibers.

The high denier thermoplastic fibers include, but are not limited to, fibers made of polyolefins (polypropylene and polypropylene copolymers, polyethylene and polyethylene copolymers), polyesters, polyamides, polyimide, polylactic acid, polyhydroxyalkanoate, polyvinyl alcohol, ethylene vinyl alcohol, nylon, polyacrylates, and copolymers thereof and mixture thereof. The high denier thermoplastic fibers may comprise an opacifying agent, as disclosed herein below, in their formulation to increase the opacity of the fibrous material made therefrom.

The high denier thermoplastic fibers may be multi-component fibers. Multi-component fibers, commonly bi-component fibers, may be in a side-by-side, sheath-core, segmented pie, ribbon, or islands-in-the-sea configuration. The sheath may be continuous or non-continuous around the core. If present, a hollow region in the fiber may be singular in number or multiple.

Examples of suitable high denier thermoplastic fibers include, but are not limited to, staple trilobal polypropylene fibers (3.3 denier 38 mm) with 1% TiO2 as supplied from FiberVisions (7101 Alcovy Road Covington, Ga., USA 30014) or staple round polyester fiber (3.0 denier, 38 mm) with 0.22% TiO2 as supplied from Maerkische Faser GmbH or staple Trilobal polyester fibers (2.5 denier, 38 mm) with 0.22% TiO2 as supplied from Maerkische Faser GmbH (Grisuten str. 13, 14727 Premnitz, Germany).

Opacifying Agent

The fibrous material of the invention comprises at least 0.2%, by weight of dry fibrous material, of an opacifying agent. Said opacifying agent may be comprised in the polymer melt formulation of the low denier thermoplastic shaped fibers and/or of the high denier thermoplastic fibers, i.e. added to the mass during the fibers production. When the opacifying agent is comprised in the polymer melt formulation, said opacifying agent is structurally encapsulated in the fibers making the fibrous material, the opacifying agent being integral to one or more of the fibers making up the fibrous material.

Suitably, the fibrous material comprises from 0.4% to 4%, or from 0.5% to 3%, or from 0.8% to 2%, or from 1% to 1.5%, by weight of dry fibrous material, of an opacifying agent.

Suitable opacifying agents include, but are not limited to, titanium dioxide, clay, calcium carbonate, zinc oxide, diatomaceous silica and combinations thereof.

Optional Cellulosic Fibers

The fibrous material of the invention may optionally comprise cellulosic fibers. Cellulosic fibers may increase the absorbency of the fibrous material. Suitable cellulosic fibers include, but are limited to, viscose, rayon, lyocell, cotton, wood pulp, regenerated cellulose and mixtures thereof.

When the cellulosic fibers are made of regenerated cellulose, they may be solid round fibers, hollow round fibers and/or shaped fibers such as multi-lobal shaped fibers, e.g. bilobal, trilobal, quatro-lobal fibers, or delta shaped, concave delta shaped, crescent shaped, oval shaped, trapezoid shaped, star shaped, square shaped, diamond shaped, U-shaped, H-shaped, C-shaped, V-shaped or other suitable shaped fibers or combinations thereof. The multi-lobal shaped fibers may be solid or hollow fibers.

Cellulosic fibers may have a length of from 2 mm to 70 mm, or from 20 to 60 mm or from 30 to 40 mm. When present, cellulosic fibers may represent from 5 to 50%, or from 10 to 40%, or from 10 to 30% by weight of the total amount of fibers.

Fibrous Materials and Physical Properties

The sheet of fibrous material suitable in the invention may include woven and nonwoven materials comprising low denier thermoplastic shaped fibers and high denier thermoplastic fibers as described above and suitably an opacifying agent.

“Nonwoven material” as used herein refers to a manufactured web of directionally or randomly orientated fibers, bonded by friction, and/or cohesion and/or adhesion, excluding paper and products which are woven, knitted, tufted, stitch-bonded incorporating binding yarns or filaments, or felted by wet-milling, whether or not additionally needled. Nonwoven materials and processes for making them are known in the art. Processes for making nonwoven materials may comprise two steps: fiber laying onto a forming surface and fiber bonding. The fiber laying step may comprise spunlaying, meltblowing, carding, airlaying, wetlaying coform and combinations thereof. The fiber bonding step may be comprised of hydroentanglement, cold calendering, hot calendering, through air thermal bonding, chemical bonding, needle punching, and combinations thereof.

In some embodiments, the sheet of fibrous material suitable in the invention is obtained by admixing low denier thermoplastic shaped staple fibers and high denier thermoplastic staple fibers in desired proportions as described below. The fibers mix is then laid down by carding process to form a web of fibrous material. The web of fibrous material is consolidated by hydroentangling process and dried to form the nonwoven sheet of fibrous material.

Whereas in some embodiments, low denier thermoplastic shaped fibers and high denier thermoplastic fibers may be admixed, homogeneously or non-homogeneously, and transformed into a sheet of fibrous material, in some other embodiments, the low denier thermoplastic shaped fibers and high denier thermoplastic fibers may be provided as separate layers which may be combined to provide a fibrous material.

The sheet of fibrous material may comprise on at least one of its surface a macroscopic three dimensional pattern which may be defined by peaks and valleys. Said three dimensional patterns may be produced by hydromolding. However, any texturing processes may be suitable to provide macroscopic three dimensional patterns. Three dimensional patterns may enhance the cleaning performance of the wipe made of said sheet as well as the aesthetic appearance of the wipe.

The sheet of fibrous material may also comprise an embossed pattern for a better aesthetic appeal, such as disclosed in U.S. Pat. No. 6,361,784.

Suitable sheets of fibrous material comprises from 20 to 90%, by weight of the total amount of fibers, of low denier thermoplastic shaped fibers and from 10 to 80%, by weight of the total amount of fibers, of high denier thermoplastic fibers. By “total amount of fibers” as used herein, it is meant the total amount of fibers constituting the sheet of fibrous material. The sheet of fibrous material may be made exclusively of low denier thermoplastic shaped fibers and high denier thermoplastic fibers or the sheet of fibrous material may comprise further types of fibers, such as cellulosic fibers. Whereas made exclusively of low denier thermoplastic shaped fibers and high denier thermoplastic fibers, or made of low denier thermoplastic shaped fibers, high denier thermoplastic fibers and optional fibers, the sheet of fibrous material comprises at least 0.2%, by weight of dry fibrous material, of an opacifying agent. Suitably, the sheet of fibrous material comprises from 0.4 to 4%, by weight of dry fibrous material, of an opacifying agent. The opacifying agent may be comprised in the low denier thermoplastic shaped fibers and/or in the high denier thermoplastic fibers and/or in the optional fibers when present.

In some embodiments, the fibrous material may comprise from 25 to 85%, or from 30 to 70%, by weight of the total amount of fibers, of low denier thermoplastic shaped fibers, from 15 to 75%, or from 30 to 70%, by weight of the total amount of fibers, of high denier thermoplastic fibers. The sheet of fibrous material may comprise from 0.4 to 4%, or from 0.5% to 3%, or from 0.8% to 2%, or from 1% to 1.5%, by weight of dry fibrous material, of an opacifying agent. Said fibrous structures may desirably have a basis weight ranging from 20 to 80 gsm, or from 25 to 50 gsm or from 30 to 45 gsm.

Fibrous materials comprising from 20 to 90%, or from 25 to 85%, or from 30 to 70%, by weight of the total amount of fibers, of low denier thermoplastic shaped fibers, from 10 to 80%, or from 15 to 75%, or from 30 to 70%, by weight of the total amount of fibers, of high denier thermoplastic fibers and at least 0.2%, by weight of dry fibrous material, of an opacifying agent, e.g. from 0.4 to 4%, or from 0.5 to 3%, or from 0.8% to 2%, or from 1 to 1.5%, by weight of dry fibrous material, of an opacifying agent exhibit such physical properties that they can be used advantageously for manufacturing wipes. Indeed, fibrous structures according to the present disclosure exhibit strength, thickness and opacity within ranges of values which make them suitable for manufacturing wipes. These wipes can find wide acceptance among consumers. Furthermore, at basis weight parity, the fibrous structures according to the present disclosure exhibit improved physical properties, i.e. higher strength, higher thickness and higher opacity, than conventional wipes not comprising the particular combination of high denier/low denier thermoplastic fibers. Hence, it is thus readily understood that the wipes of the invention may deliver to the consumers the benefits of high basis weight conventional wipes at lower basis weight while enabling to reduce manufacturing cost. Without being bound by theory, it is believed that the low denier thermoplastic shaped fibers contribute to the strength, coverage and opacity of the fibrous material whereas the high denier thermoplastic fibers contribute to the thickness of the fibrous material. Opacifying agents contribute to the opacity of the fibrous structure insuring a consistent and consumer-friendly appearance to the wipe.

Suitably, in the various embodiments described herein, the ratio low denier thermoplastic shaped fibers to high denier thermoplastic fibers (w/w) may be comprised from 1 to 4.0 or from 1.4 to 3.0 or from 1.5 to 2.5.

Advantageously, a wipe comprising a sheet of fibrous material having a basis weight comprised between 30 gsm and 45 gsm and comprising from 20 to 90%, or from 25 to 85%, or from 30 to 70%, by weight of the total amount of fibers, of low denier thermoplastic shaped fibers, from 10 to 80%, or from 15 to 75%, or from 30 to 70%, by weight of the total amount of fibers, of high denier thermoplastic fibers and from 0.4 to 4%, or from 0.5 to 3%, or from 0.8 to 2%, or from 1 to 1.5%, by weight of dry fibrous material, of an opacifying agent, exhibits an opacity in the range of from 45 to 80%, a CD tensile strength in the range of from 12 to 45 N, and a caliper in the range of from 0.45 mm to 1.1 mm, as measured according to the methods described in the Test Methods section. Thus, these wipes exhibit physical properties of higher basis weight conventional wipes at lower basis weight. Thus for example, a 30 gsm fibrous structure according to the present disclosure may exhibit the physical properties of at least a 40 gsm conventional wipe. Typically, opacity in the range of from 45 to 80%, CD tensile strength in the range of from 12 to 45 N and caliper in the range of from 0.45 mm to 1.1 mm are wipes properties representative of wipes that consumers consider as desirable and acceptable. In some embodiments, the wipes exhibit an opacity in the range of from 45 to 80%, or from 50 to 75%, or from 55 to 70%, a CD tensile strength in the range of from 12 to 45 N, or from 15 to 40 N, or from 16 to 35 N and a caliper in the range of from 0.45 mm to 1.1 mm, or from 0.5 to 1.05 mm, or from 0.55 to 1 mm.

In some embodiments, the wipe may comprise a sheet of fibrous material having a basis weight comprised between 30 gsm and 45 gsm and comprising from 25 to 85%, by weight of the total amount of fibers, of low denier thermoplastic shaped fibers, from 15 to 75%, by weight of the total amount of fibers, of high denier thermoplastic fibers and from 0.8 to 2%, by weight of dry fibrous material, of an opacifying agent. The wipe may exhibit an opacity of from 50 to 75%, a CD tensile strength of from 16 to 35 N and a caliper of from 0.5 mm to 1 mm. Desirably, the low denier thermoplastic shaped fibers have a denier in the range of 0.8 dpf to 1 dpf and the high denier thermoplastic fibers have a denier in the range of 2.7 dpf to 4 dpf.

Examples of particularly desirable wipes include wipes comprising a sheet of fibrous material having a basis weight comprised between 30 gsm and 45 gsm and comprising from 25 to 85%, by weight of the total amount of fibers, of polypropylene low denier shaped fibers, from 15 to 75%, by weight of the total amount of fibers, of polyethylene terephtalate high denier fibers and from 0.8 to 2%, by weight of fibrous material, of Titanium dioxide. In some embodiments, the polypropylene low denier shaped fibers are trilobal shaped fibers and the polyethylene terephtalate high denier fibers are round fibers. In some embodiments, the polypropylene low denier shaped fibers are fibers having a denier in the range of from 0.8 dpf to 1 dpf, e.g. trilobal shaped fibers having a denier in the range of 0.8 dpf to 1 dpf and the polyethylene terephtalate high denier fibers are fibers having a denier in the range of 2.7 dpf to 4 dpf, e.g. round fibers having a denier in the range of 2.7 dpf to 4 dpf. Suitably, the wipes exhibit an opacity of from 45% to 80% or from 50% to 75%, a CD tensile strength of from 12 to 45 N or from 16 N to 35 N and a caliper of from 0.45 to 1.1 mm or from 0.5 mm to 1 mm.

The sheet of fibrous material of the present disclosure, i.e. the sheet of dry fibrous material, may be impregnated with a lotion composition to provide a so-called wet wipe. Typical lotion compositions are predominantly water based compositions and can contain a variety of other ingredients. These are usually, surfactants, humectants, emollients, rheology modifiers, soothing agents, cleansers, anti-microbials, preservatives, perfumes and softeners. Examples of suitable lotion compositions include, but are not limited to, lotion compositions comprising at least 60%, or at least 70%, or at least 85% of water and, when present, from 0.01 to 5% of surfactants, humectants, emollients, rheology modifiers, soothing agents, cleansers, anti-microbials, preservatives, perfumes, softeners. All components are not necessarily present in the lotion compositions.

Advantageously, when the sheets of fibrous material according to the present disclosure are wetted by a lotion composition to provide so-called wet wipes, they exhibit performances, i.e. strength, thickness and opacity, within desirable and acceptable ranges. For instance, wet wipes comprising a sheet of fibrous material comprising from 20 to 90%, by weight of the total amount of fibers, of low denier thermoplastic shaped fibers, from 10 to 80%, by weight of the total amount of fibers, of high denier thermoplastic fibers and from 0.4 to 4%, by weight of dry fibrous material, of an opacifying agent, exhibit an opacity in the range of from 45% to 65%, a CD tensile strength in the range of from 12 N to 30 N and a caliper in the range of from 0.45 mm to 0.8 mm. Opacity in the range of from 45 to 65%, CD tensile strength in the range of from 12 N to 30 N and caliper in the range of from 0.45 mm to 0.8 mm are wipes properties typically representative of wipes that consumers consider as desirable and acceptable. The sheet of fibrous material may have a basis weight in the range of 20 to 80 gsm, or from 25 to 50 gsm or from 30 to 45 gsm. In some embodiments, the wet wipes exhibit an opacity in the range of from 48% to 62%, or from 50 to 60%, a CD tensile strength in the range of from 15 to 27 N, or from 17 to 25 N and a caliper in the range of from 0.5 mm to 0.75 mm, or from 0.55 to 0.7 mm. The ability of the present wipes to still maintain desirable properties when in wet state is quite advantageous. Typically, one problem accoutered when wetting a dry wipe is that the lotion composition which impregnates the fibrous material can reduce the strength, thickness and opacity of the resulting wet wipe. Reduction of opacity is undesirable because consumers may perceive the relatively low opacity as indicating a thin or low quality wipe. Maintaining desired caliper is desirable from a consumer acceptance point of view because consumers typically link caliper to efficient cleaning ability, flexibility and hand protection. From a manufacturing point of view, the possibility of reducing the basis weight of the fibrous material whilst maintaining the caliper of the fibrous material, particularly when in a wet state, is highly appreciated. Indeed, this avoids resizing the dimensions of the package, changing the artwork. Furthermore, since a desired caliper is maintained at lower basis weight, the appearance of the package remains unchanged, i.e. it remains appealing and contributes to give a high quality impression at the shelves for consumers.

In some embodiments, the wet wipe comprises a sheet of fibrous material having a basis weight comprised from 30 gsm and 45 gsm and comprising from 25 to 85%, by weight of the total amount of fibers, of low denier thermoplastic shaped fibers, from 15 to 75%, by weight of the total amount of fibers, of high denier thermoplastic fibers and from 0.8 to 2%, by weight of dry fibrous structure, of an opacifying agent exhibits, in the wet state, an opacity of from 45% to 65%, a CD tensile strength of from 12 N to 30 N and a caliper of from 0.45 mm to 0.8 mm.

### Test Methods

The methods disclosed herein are applicable for measuring the caliper, CD tensile strength and opacity of either dry wipes or wet wipes.
Should the wipes be individual packaged wipes, then the basis weight, caliper, CD tensile strength and opacity are measured for 12 individual packaged wipes.

### Sample Preparation

Six glass dishes, each with dimensions approximately 20 cm wide×30 cm long×4 cm deep are numbered 1-6. The first two dishes are filled with 2 L of distilled water; the second dish is filled with 2 L of a mixture of 50% water and 50% methanol by weight; the fourth dish is filled with 2 L of pure methanol; and the fifth and sixth dishes are each filled with 2 L of distilled water.
From the wipes package, 12 individual wipes are selected as follows:

4 wipes from the top

4 wipes from the middle

4 wipes from the bottom
The wipes are placed individually into the liquid in the first dish until all of the wipes are submerged in the liquid. The wipes in the dish are agitated gently for three minutes, then removed one at a time using tweezers, allowed to drip for 30 seconds, then placed into the liquid in the second dish. This process is repeated to move the wipes through each dish in the series consecutively, with 3 minutes of agitation in each dish before being transferred to the next dish and 30 seconds of drip time in-between. After removal from the final dish (Dish No. 6), the wipes are each suspended by one edge from a taut horizontal string to dry for 16 hours in controlled environment of 23±2° C., and 50±5% relative humidity.
The liquid in each dish is discarded and replaced with fresh liquid after each batch of 12 wipes. Basis Weight (Mass per Unit Area)
The basis weight of each wipe prepared as above in the Sample Preparation section is determined according to INDA Standard Test WSP 130.1 (05). If the area of any wipe is less than 500 cm² then the entire wipe is measured and weighed according to the method above to determine its basis weight. All testing is conducted in an atmosphere of 23±2° C., and 50±5% relative humidity. The basis weight of the wipes is calculated as the average of the 12 individual wipes and reported in units of grams per square meter (gsm) to within ±0.5 gsm.

### Thickness (Caliper)

From the wipes package, 12 individual wipes are selected as follows:

4 wipes from the top

4 wipes from the middle

4 wipes from the bottom
When measuring the thickness of wet wipes, the thickness of each wipe is determined immediately upon removal from the package to minimize any loss of liquid from evaporation. All testing is conducted in an atmosphere of 23±2° C., and 50±5% relative humidity.
The thickness of the wipe is measured using a dial gauge or digital equivalent with a resolution of ±1 μm and a circular “foot” having a flat horizontal bottom surface with an area of approximately 25 cm². A suitable gauge is an Ono Sokki digital caliper gauge DG-3610 connected to an Ono Sokki linear gauge sensor GS-503, or equivalent. The gauge is mounted over a base having a horizontal flat rigid upper surface, such that the entire bottom surface of the foot contacts the upper surface of the base. The force exerted by the foot on the base or on a material inserted between the foot and the base is 1.25 N and is independent of the thickness of the material. The force exerted by the foot of the gauge can be measured by mounting the gauge over a suitable top-loading balance such that the balance pan is in the same relative position to the gauge as the base. If necessary, the force is adjusted by adding weight to the foot such that the pressure exerted by the foot is 500±10 Pa.

The thickness of the wipe is determined by reading the gauge with the foot resting on the base (G₀). The foot of the gauge is then raised and the wipe is laid flat on the base with the center portion of the wipe under the foot. The foot is lowered gently onto the material & the gauge reading taken 5 seconds after complete release of the foot (G_{T}). The thickness of the wipe at that location is the difference between the two readings (G_{T}-G₀).
The thickness of each of the 12 wipes is determined in this fashion and the numeric average is reported as the caliper to within ±0.01 mm

### CD Tensile Strength

A suitable tensile tester such as an MTS Alliance with MTS Testworks version 4.0 or equivalent is used.

The tester is equipped with steel grips having smooth, flat clamping surfaces measuring 75 mm wide and 25 mm tall. The clamping surfaces of each grip are parallel and the edges of the clamping surfaces are aligned horizontally with the edges of the opposing clamping surface in the same grip.

A load cell is used so that the maximum load measured is within 10-90% of the maximum capacity of the load cell.
The instrument is calibrated according to the manufacturer's specification.

All testing is carried out in an atmosphere of 23±2° C. and 50±5% relative humidity. From the wipes package, 12 individual wipes are selected as follows:

4 wipes from the top

4 wipes from the middle

4 wipes from the bottom
Immediately upon removal from the package, a specimen is cut from each wipe and its tensile strength determined in order to minimize any loss of liquid from evaporation when measuring the tensile strength of wet wipes.
Using a sharp blade and suitable guide, a 50 mm wide specimen is cut from the center portion of each wipe parallel to the edges of the wipe along the entire length (or width) of the wipe. The edges of the specimen must be free of nicks and other spurious imperfections. Specimens are cut with the length of the specimen parallel to the machine direction of the wipe from two of the group of four wipes taken from the top of the package, and perpendicular to the machine direction from the other two wipes in this group. Similarly, two specimens are cut with the length of the specimen parallel to the machine direction of the wipe, and two specimens are cut with the length of the specimen perpendicular to the machine direction of the wipe for each of the groups of four wipes taken form the middle and bottom of the package. The specimens are labeled as to their position in the package and their orientation. If the machine direction of the wipe is not discernable, then a particular direction is chosen and two of the specimens are cut from each group of four wipes with the with the length of the specimen parallel to this direction of the wipe, and two specimens are cut from the other two wipes with the length of the specimen perpendicular to this direction of the wipe.

The gauge length of the tensile tester is set to 100 mm and a specimen is mounted with minimal slack with is longitudinal centerline along the axis of the load cell so that the mid point of the specimen is centered between the grips. The load cell must read between 0 and 0.04 N of force after mounting the sample. If the value exceeds 0.05 N, then the sample should be re-clamped. Clamping force must be sufficient to prevent slippage of the specimen during testing. The specimen is then extended at 500 mm/min until it breaks completely while recording the force and displacement.

The maximum force recorded is the tensile strength of the specimen. The tensile strength is averaged for the six specimens cut with the length of the specimen parallel to the machine direction of the wipe. This average is reported as the machine direction tensile strength. Similarly, the tensile strength is averaged for the six specimens cut with the length of the specimen perpendicular to the machine direction of the wipe. This average is reported as the transverse direction tensile strength. Where the machine direction of the wipe is not discernable, the direction having the higher average tensile strength is the machine direction tensile strength, and the direction having the lower average tensile strength is the transverse direction tensile strength. The results are reported in Newtons (per 50 mm of specimen width) to within ±0.1 N. The thickness of the specimen is not taken into account in calculating the tensile strength.

### Opacity

Opacity is a measure of the capacity of a material to obscure the background behind it. Opacity measurements are sensitive to material thickness and degree of pigmentation or level of opacifier (e.g. TiO₂ particles). The value for opacity is obtained by dividing the reflectance obtained with a black backing (RB) for the material, by the reflectance obtained for the same material with a white background (WB). This is called the contrast ratio (CR) method.

$$\% Opacity = \frac{RB}{RW} \times 100$$

Using an XYZ color scale, opacity is defined herein as

$$\% Opacity = \frac{Y reading over black plate}{Y reading over white plate} \times 100$$

A Hunter Labscan XE, Hunter D25DP9000 or equivalent colorimeter/spectrophotometer is used. The instrument is configured as follows:

Port Size: 2 inches (50.8 mm)

Area View 1.75 inches (44.45 mm)

Geometry 45°/0°

Color Scale XYZ

Illuminant D65

Observer 10°
The colorimeter is calibrated using the standard gloss black glass and gloss white tile supplied with the instrument according to the manufacturer's instructions.

All testing is carried out in an atmosphere of 23±2° C. and 50±5% relative humidity.

From the wipes package, 12 individual wipes are selected as follows:

4 wipes from the top

4 wipes from the middle

4 wipes from the bottom

When measuring the opacity of wet wipes, the % opacity of each wipe is determined immediately upon removal from the package to minimize any loss of liquid from evaporation. Each wipe is placed centrally on the white tile and inserted into the colorimeter according to the manufacturer's instructions. The machine direction of the specimen should be aligned front-to-back in the instrument. The Y reading is recorded to the nearest 0.1 unit. The procedure is repeated using the black standard plate instead of the white standard tile. (Note: the machine direction is the direction with greater tensile strength, as described in the Tensile Strength test above).

Twelve specimens are measured and the % opacity results averaged to obtain the % opacity value for the material.

### EXAMPLES

The following examples are non-limiting examples of fibrous material according to the present disclosure. Examples 1 to 4

The following nonwoven fibrous materials (examples 1 to 4) were prepared by first blending and mixing the staple fibers (38 mm) in proportion as disclosed in the table herein below (table 1).

The staple fiber blends were formed into a web of desired basis weight by using carding technology well known in the industry. A Double Excelle Vario three-doffer card from NSC Nonwoven, 59336 TOURCOING CEDEX, France was used. The carded webs were then consolidated by using hydroentanglement technology well known in the industry. The system used was a JETlace03000 from Rieter Perfojet (F-38330 Montbonnot—France) with a working width of 500 mm. The hydroentanglement system had a pre-wetting conveyor and three cylinders with two injectors each. In total of three injectors (two on the first cylinder and one on the second one) were used for consolidation and strength generation. Each jet was equipped with 120 micron strips with 42 holes/inch. The webs were dried by using through air drying technology well known in the industry (PERFOdry3000 with a roll diameter of 2000 mm from Rieter Perfojet) to form the nonwoven sheet of fibrous materials. The nonwoven material was wound by using a state of the art winder system (EasyWinder from NSC nonwoven).

TABLE 1

| | Fibers | | | | |
|---|---|---|---|---|---|
| | Trilobal | Trilobal | Trilobal | Round | |
| | PP | PP | PP | PET | Viscose |
| | (%) | (%) | (%) | (%) | (%) |
| denier | 1.2 | 0.9 | 3.3 | 3.0 | 1.5 |
| TiO₂ % | 0.5 | 1.0 | 1.0 | 0.22 | 1.0 |
| Ex.1 | 50 | — | — | 30 | 20 |
| Ex.2 | — | 55 | 25 | — | 20 |
| Ex.3 | — | 70 | 30 | — | — |
| Ex.4 | — | 60 | 25 | — | 15 |

The basis weight, opacity, CD tensile strength and caliper of the fibrous materials according to examples 1 to 4 were measured according to the methods described herein. Results are presented in table 2.

TABLE 2

| | Basis weight | Opacity | CD Tensile | Caliper |
|---|---|---|---|---|
| | (gsm) | (%) | (N) | (mm) |
| Ex. 1 | 41.8 | 65.5 | 18.2 | 0.68 |
| Ex. 2 | 38.1 | 65.4 | 20.1 | 0.60 |
| Ex. 3 | 36.4 | 67.2 | 28.4 | 0.7 |
| Ex. 4 | 34.7 | 61.6 | 25.4 | 0.89 |

The caliper, CD tensile strength and opacity of the fibrous materials according to examples 1 to 4 were measured according to the methods described herein when wetted with a lotion composition comprising the following components:

| Components | Weight Percent |
|---|---|
| Water | Q.S. |
| Disodium EDTA | 0.100 |
| Xanthan Gum^{†} | 0.180 |
| Sodium Benzoate | 0.120 |
| PEG-40 Hydrogenated | 0.440 |
| Castor Oil | |
| Citric Acid | 0.530 |
| Trisodium Citrate | 0.330 |
| Benzyl Alcohol | 0.300 |
| Euxyl ® PE9010 | 0.300 |
| Abil Care 85 | 0.100 |

^{†}Xanthan FG from Jungbunzlauer, Newton Center, MA

Results are presented in table 3.

TABLE 3

| | Saturation | | | |
|---|---|---|---|---|
| | with lotion | | CD | |
| | (% by | Opacity | Tensile | Caliper |
| | weight) | (%) | (N) | (mm) |
| Ex. 1 | 370 | 59.5 | 12.7 | 0.61 |
| Ex. 2 | 430 | 53.4 | 16.1 | 0.51 |
| Ex. 3 | 470 | 55.5 | 21.1 | 0.61 |
| Ex. 4 | 400 | 53.9 | 22.4 | 0.68 |

Commercially Available Fibrous Materials

The basis weight, opacity, CD tensile strength and caliper of commercially available fibrous materials (table 4) were measured according to the methods described herein. Results are presented in table 5.

TABLE 4

| | Fibers | | | |
|---|---|---|---|---|
| | Trilobal | Round | Round | |
| | PP | PET | PP | Viscose |
| | (%) | (%) | (%) | (%) |
| denier | 1.2 | 1.2 | 1.5 | 1.5 |
| TiO₂ % | 0.5 | 0.22 | 0.5 | 1.0 |
| Ref. 1¹ | — | — | 80 | 20 |
| Ref. 2² | 40 | 40 | — | 20 |

¹Sawatex ® 2802, as supplied by Sandler AG, Germany.
²Sawatex ® 2666, as supplied by Sandler AG, Germany.

TABLE 5

| | Basis | Opacity | CD Tensile | Caliper |
|---|---|---|---|---|
| | weight | (%) | (N) | (mm) |
| Ref. 1 | 49.8 | 57.2 | 24.2 | 0.73 |
| Ref. 2 | 44.5 | 60.9 | 25.8 | 0.66 |

The CD tensile strength, caliper and opacity of the commercially available fibrous materials were measured according to the methods described herein when wetted with a lotion composition comprising the following components:

| Components | Weight Percent |
|---|---|
| Water | Q.S. |
| Disodium EDTA | 0.100 |
| Xanthan Gum^{†} | 0.180 |
| Sodium Benzoate | 0.120 |
| PEG-40 Hydrogenated | 0.440 |
| Castor Oil | |
| Citric Acid | 0.530 |
| Trisodium Citrate | 0.330 |
| Benzyl Alcohol | 0.300 |
| Euxyl ® PE9010 | 0.300 |
| Abil Care 85 | 0.100 |

^{†}Xanthan FG from Jungbunzlauer, Newton Center, MA

Results are presented in table 6.

TABLE 6

| | Saturation | | | |
|---|---|---|---|---|
| | with lotion | | CD | |
| | (% by | Opacity | Tensile | Caliper |
| | weight) | (%) | (N) | (mm) |
| Ref. 1 | 300 | 46.9 | 15.5 | 0.53 |
| Ref. 2 | 390 | 49.7 | 20.8 | 0.54 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

1-15. (canceled)

16. A wipe comprising a sheet of fibrous material, wherein the sheet of fibrous material comprises:
from 20% to 90%, by weight of the total amount of fibers, of thermoplastic shaped fibers having a denier of up to 1.2 dpf;
from 10% to 80%, by weight of the total amount of fibers, of thermoplastic fibers having a denier of at least 2.2 dpf; and
wherein the sheet of fibrous material comprises at least 0.2%, by weight of dry fibrous material, of an opacifying agent.

17. The wipe according to claim 16, wherein the sheet of fibrous material has a basis weight of from 30 g/m² to 45 g/m², and comprises from 0.4 to 4% by weight of dry fibrous material, and comprises an opacifying agent exhibiting:
an opacity of from 45 to 80% measured according to the method described herein;
a CD tensile strength of from 12 to 45 N measured according to the method described herein; and
a caliper of from 0.45 to 1.1 mm measured according to the method described herein.

18. The wipe according to claim 16, wherein the thermoplastic shaped fibers have a denier in the range of from 0.6 dpf to 1.2 dpf and the thermoplastic fibers have a denier in the range of from 2.2 dpf to 6 dpf.

19. The wipe according to claim 16, wherein the thermoplastic shaped fibers are selected from the group consisting of bilobal shaped, trilobal shaped, quatro-lobal shaped, delta shaped, concave delta shaped, crescent shaped, oval shaped, star shaped, square shaped, U-shaped, H-shaped, C-shaped, V-shaped, diamond shaped fibers, and combinations thereof

20. The wipe according to claim 16, wherein the thermoplastic fibers are selected from the group consisting of round fibers, bilobal shaped, trilobal shaped, quatro-lobal shaped, delta shaped, concave delta shaped, crescent shaped, trapezoid shaped, trapezoid shaped, oval shaped, star shaped, square shaped, U-shaped, H-shaped, C-shaped, V-shaped, diamond shaped fibers, and any combinations thereof.

21. The wipe according to claim 16, wherein the thermoplastic shaped fibers and/or the thermoplastic fibers are selected from the group consisting of polypropylene, polyethylene, polyesters, polyamides, polyimide, polylactic acid, polyhydroxyalkanoate, polyvinyl alcohol, ethylene vinyl alcohol, nylon, polyacrylates, and copolymers thereof, and mixture thereof.

22. The wipe according to claim 17, wherein the opacifying agent is selected from the group consisting of titanium dioxide, clay, calcium carbonate, zinc oxide, diatomaceous silica, and combinations thereof.

23. The wipe according to claim 16, wherein the sheet of fibrous material comprises:
from 25% to 85%, by weight of the total amount of fibers, of thermoplastic shaped fibers having a denier in the range of from 0.8 to 1 dpf, and/or
from 15% to 75%, by weight of the total amount of fibers, of thermoplastic fibers having a denier in the range of from 2.7 to 4 dpf, and wherein the sheet of fibrous material comprises from 0.8% to 2%, by weight of dry fibrous material, of an opacifying agent.

24. The wipe according to claim 16, wherein the thermoplastic shaped fibers are polypropylene fibers, and wherein the thermoplastic fibers are polyethylene terephtalate fibers, and wherein the opacifying agent is titanium dioxide.

25. The wipe according to claim 16, wherein the sheet of fibrous material is obtained by carding and hydroentangling a mixture of the thermoplastic shaped fibers and the thermoplastic fibers.

26. The wipe according to claim 25, wherein the sheet of fibrous material further comprises cellulosic fibers selected from the group consisting of viscose, rayon, lyocell, cotton, wood pulp, regenerated cellulose and any combinations thereof.

27. The wipe according to claim 16 further comprising a lotion composition.

28. The wipe according to claim 27, wherein the thermoplastic shaped fibers result from the decomposition of splittable fibers.

29. A wet wipe comprising a sheet of fibrous material having a basis weight comprised from 30 g/m² to 45 g/m², wherein the sheet of fibrous material comprises:
from 20% to 90%, by weight of the total amount of fibers, of thermoplastic shaped fibers having a denier of up to 1.2 dpf;
from 10% to 80%, by weight of the total amount of fibers, of thermoplastic fibers having a denier of at least 2.2 dpf;
wherein the sheet of fibrous material comprises from 0.4% to 4%, by weight of dry fibrous material, of an opacifying agent; and
wherein the wet wipe exhibits:
an opacity of from 45 to 65% measured according to the method described herein;
a CD tensile strength of from 12 to 30 N measured according to the method described herein; and
a caliper of from 0.45 to 0.8 mm measured according to the method described herein.

30. The wipe according to claim 29 wherein the sheet of fibrous material comprises:
from 25% to 85%, by weight of the total amount of fibers, of thermoplastic shaped fibers having a denier in the range of from 0.8 to 1 dpf; and/or
from 15% to 70%, by weight of the total amount of fibers, of thermoplastic fibers having a denier in the range of from 2.7 to 4 dpf; and/or
from 0.8% to 2%, by weight of dry fibrous material, of an opacifying agent.
